(19) United States
(12) Patent Application Publication
(10) Pub. No.: US 2025/0346297 A1
(43) Pub. Date: Nov. 13, 2025

(54) FRAME MEMBER FOR VEHICLE AND VEHICLE-BODY FRONT STRUCTURE

(71) Applicant: MAZDA MOTOR CORPORATION, Hiroshima (JP)

(72) Inventors: Nobutaka TANIGUCHI, Aki-gun (JP); Yui KUROKI, Aki-gun (JP)

(73) Assignee: MAZDA MOTOR CORPORATION, Hiroshima (JP)

(21) Appl. No.: 19/057,566

(22) Filed: Feb. 19, 2025

(30) Foreign Application Priority Data
May 10, 2024 (JP) 2024-077070

(51) Int. Cl. B62D 21/15; B62D 25/08

(52) U.S. Cl. CPC B62D 21/155; B62D 25/085

(57) ABSTRACT

A frame member comprises a first vertical wall, a second vertical wall, a first lateral wall, a second lateral wall, a first inner wall arranged between the first and second vertical walls in a vehicle width direction and extending in a vertical direction, interconnecting the first and second lateral walls, and a second inner wall arranged between the second vertical wall and the first inner wall in the vehicle width direction and extending in the vertical direction, interconnecting the first and the second lateral walls. Each of the first and second lateral walls comprises a first portion interconnecting the first vertical wall and the first inner wall, a second portion interconnecting the first and second inner walls, and a third portion interconnecting the second vertical wall and the second inner wall. Each bending rigidity of the first portion and the third portion is larger than that of the second portion.

### BACKGROUND OF THE INVENTION

The present invention relates to a frame member for a vehicle and a vehicle-body front structure.

The US patent document (U.S. Pat. No. 6,502,874B) discloses a front part of an automobile comprising a frame member and a crash box which is an impact absorbing member connected to a front portion of the frame member. It is also disclosed that when the impact caused by a vehicle collision or the like is applied to the front part of the automobile from a forward side, the crash box has repeated buckling deformation in an extension direction thereof, so that the above-described impact to be transmitted to a vehicle body is absorbed.

However, in a case where the above-described crash box is deformed unexpectedly, a collision load is not transmitted to the frame member from the crash box efficiently, so that there is a concern that the collision-load absorption amount (function) by means of the frame member may deteriorate.

### SUMMARY OF THE INVENTION

An object of the present invention is to provide a frame member for a vehicle which is configured to absorb the collision load transmitted via the impact absorbing member and a vehicle-body front structure provided with this frame member for the vehicle, which can properly improve the collision-load absorption amount (function) by means of the frame member.

An aspect of the present invention is the frame member for the vehicle, which extends in a longitudinal direction, has a closed-cross section perpendicular to an extension direction thereof, and is configured to absorb a collision load by an impact absorbing member arranged in front thereof, comprising a first vertical wall extending in a vertical direction at the closed-cross section, a second vertical wall arranged on an inward side, in a vehicle width direction, of the first vertical wall and extending in the vertical direction at the closed-cross section, a first lateral wall extending in the vehicle width direction at the closed-cross section, interconnecting respective upper ends of the first vertical wall and the second vertical wall, a second lateral wall extending in the vehicle width direction at the closed-cross section, interconnecting respective lower ends of the first vertical wall and the second vertical wall, and forming the closed-cross section together with the first vertical wall, the second vertical wall, and the first lateral wall, a first inner wall arranged between the first vertical wall and the second vertical wall in the vehicle width direction and extending in the vertical direction at the closed-cross section, interconnecting the first lateral wall and the second lateral wall, and a second inner wall arranged between the second vertical wall and the first inner wall in the vehicle width direction and extending in the vertical direction at the closed-cross section, interconnecting the first lateral wall and the second lateral wall, wherein each of the first lateral wall and the second lateral wall comprises a first portion interconnecting the first vertical wall and the first inner wall, a second portion interconnecting the first inner wall and the second inner wall, and a third portion interconnecting the second vertical wall and the second inner wall, and each bending rigidity of the first portion and the third portion is larger than that of the second portion.

According to this structure, since the bending rigidity of the first portion and the bending rigidity of the third portion are larger than that of the second portion, the support rigidity for supporting the impact absorbing member can be enhanced, compared to a case where the bending rigidity of the first portion and the bending rigidity of the third portion are smaller than that of the second portion. Thereby, when the collision load is applied to the vehicle-body front structure from the forward side, the impact absorbing member is compressed easily, so that the impact absorbing member is suppressed from being deformed unexpectedly. Consequently, the collision load is transmitted to the frame member from the impact absorbing member efficiently, so that the collision-load absorption amount (function) by means of the frame member can be improved, compared to the case where the impact absorbing member is deformed unexpectedly.

If the bending rigidity of the second portion is extremely large, when the collision load is applied to the frame member from the forward side, there is a case where the second portion hinders proper compression of the frame member along its extension direction. According to the present invention, however, since the bending rigidity of the second portion is smaller than that of the first portion and the third portion, it can be suppressed that the second portion hinders the proper compression of the frame member along its extension direction, compared to a case where the bending rigidity of the second portion is that of each of the first portion and the third portion or larger. Thereby, the frame member is easily and uniformly compressed in the extension direction even when the collision load is applied to the frame member from the forward side. Consequently, the collision-load absorption amount (function) by means of the frame member can be improved, compared to the case where the bending rigidity of the second portion is that of each of the first portion and the third portion or larger.

As described above, in the frame member for the vehicle which is configured to absorb the collision load transmitted via the impact absorbing member or in the vehicle-body front structure provided with this frame member for the vehicle according to the present invention, the collision-load absorption amount (function) by means of the frame member can be properly improved.

The present invention will become apparent from the following description which refers to the accompanying drawings.

### BRIEF DESCRIPTION OF THE DRAWINGS

FIG. 1 is a side view of a vehicle-body front structure according to an embodiment of the present invention.

FIG. 2 is a plan view of the vehicle-body front structure shown in FIG. 1.

FIG. 3 is a plan view of an upper structural body shown in FIG. 1.

FIG. 4 is a side view of the upper structural body shown in FIG. 1.

FIG. 5 is a sectional view taken along line V-V of FIG. 3.

FIG. 6 is a perspective view of a cross member shown in FIG. 3, when viewed from an oblique rearward side FIG. 7 is a sectional view taken along line VII-VII of FIG. 4.

FIG. 8 is a sectional view taken along line VIII-VIII of FIG. 7.

### DETAILED DESCRIPTION OF THE INVENTION

Hereafter, a frame member for a vehicle and a vehicle-body front structure according to an embodiment of the present invention will be described referring to the accompanying drawings. The following description is mealy an exemplified embodiment, and therefore the present invention is not be limited in its applications or uses by that.

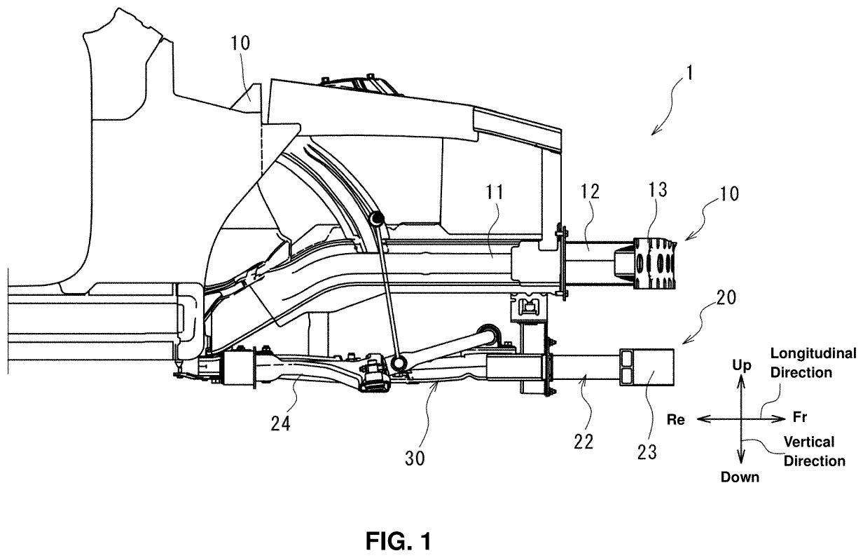

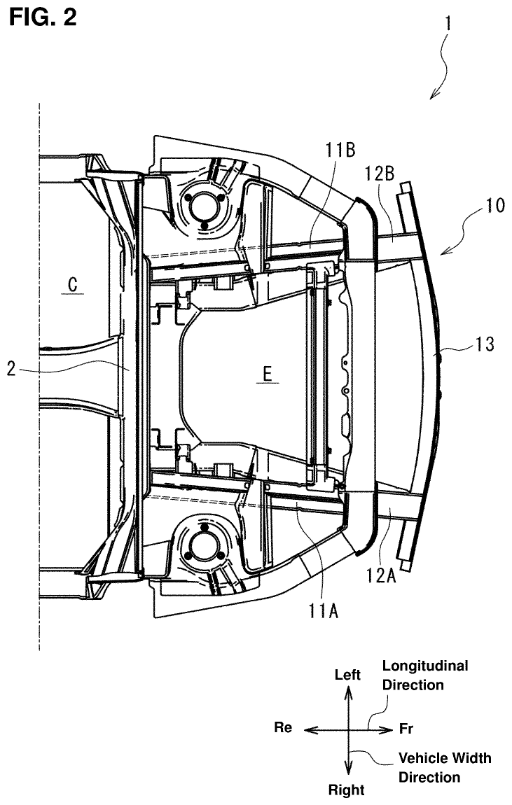

FIG. 1 is a side view of a vehicle-body front structure 1 according to the present embodiment. FIG. 2 is a plan view of the vehicle-body front structure 1 shown in FIG. 1. The vehicle-body front structure 1 of the present embodiment is the one for automobiles or the like. In the flowing description, respective longitudinal, width, and vertical directions of a vehicle provided with the vehicle-body front structure 1 will be described simply as a “longitudinal direction,” a “vehicle width direction,” and a “vertical direction” sometimes. In some cases, one side of a vehicle body which is located on a vehicle's center-line side in the vehicle width direction will be described as an inward side, in the vehicle width direction, of the vehicle body, and the other side of the vehicle body which is located on an opposite side, in the vehicle width direction, to the vehicle's center-line side will be described as an outward side, in the vehicle width direction, of the vehicle body. The vehicle width direction matches a lateral direction of the vehicle.

As shown in FIG. 1, the vehicle-body front structure 1 comprises an upper structural body 10 and a lower structural body 20 arranged below the upper structural body 10. The vehicle-body front structure 1 of the present embodiment is configured such that a collision load which the vehicle-body front structure 1 receives when the vehicle hits against another vehicle, an obstacle or the like is dispersed and absorbed by the upper structural body 10 and the lower structural body 20.

Referring to FIGS. 1 and 2, the upper structural body 10 comprises a pair of front side frames 11A, 11B, a pair of main crash cans 12A, 12B, and a main bumper reinforcement 13. In the flowing description, in a case where the pair of front side frames 11A, 11B need not to be referred to separately, one of these frames 11A, 11B will be described as a front side frame 11 simply sometimes. Likewise, in a case where the pair of main crash cans 12A, 12B need not to be referred to separately, one of these crash cans 12A, 12B will be described as a main crash can 12 simply sometimes.

The pair of front side frames 11A, 11B are arranged in the vehicle width direction with a specified gap formed therebetween. The front side frame 11 extends in the longitudinal direction. The front side frame 11 has a closed-cross section perpendicular to its extension direction. The front side frame 11 of the present embodiment is made of aluminum. The “aluminum” used in this specification includes pure aluminum and aluminum alloy.

Respective front ends of the front side frames 11A, 11B are fixed to the main crash cans 12A, 12B corresponding thereto. Specifically, the front side frame 11A is fixed to the main crash can 12A, and the front side frame 11B is fixed to the main crash can 12B. A rear end of the front side frame 11 is fixed to a dash panel 2 which separates an engine room E from a cabin C.

The main crash can 12 is a member to absorb the collision load applied from a forward side of the vehicle. The pair of main crash cans 12A, 12B are arranged in the vehicle width direction with a specified gap therebetween. The main crash can 12 extends in the longitudinal direction. The main crash can 12 has a closed-cross section perpendicular to the longitudinal direction. The main crash can 12 of the present embodiment is made of aluminum.

The main crash cans 12A, 12B are respectively arranged between the front side frames 11A, 11B and the main bumper reinforcement 13. Respective front ends of the main crash canes 12A, 12B are fixed to the main bumper reinforcement 13. Thus, the main crash cans 12A, 12B are interconnected via the main bumper reinforcement 13. Respective rear ends of the main crash cans 12A, 12B are fixed to the corresponding front side frames 11A, 11B.

Specifically, the rear and of the main crash can 12A is fixed to the front side frame 11A, and the rear end of the main crash can 12B is fixed to the front side frame 11B.

The main bumper reinforcement 13 extends in the vehicle width direction. The main crash cans 12A, 12B are fixed to the main bumper reinforcement 13 at their front ends. Thus, the main bumper reinforcement 13 interconnects the main crash cans 12A, 12B.

When the collision load is applied to the main bumper reinforcement 13 from the forward side of the vehicle, part of the collision load is absorbed by the main crash can 12 and the front side frame 11. Specifically, the collision load applied to the main bumper reinforcement 13 makes the main crash can 12 and the front side frame 11 crush, so that the part of the collision load is absorbed by these members 12, 11 through their crushing deformation.

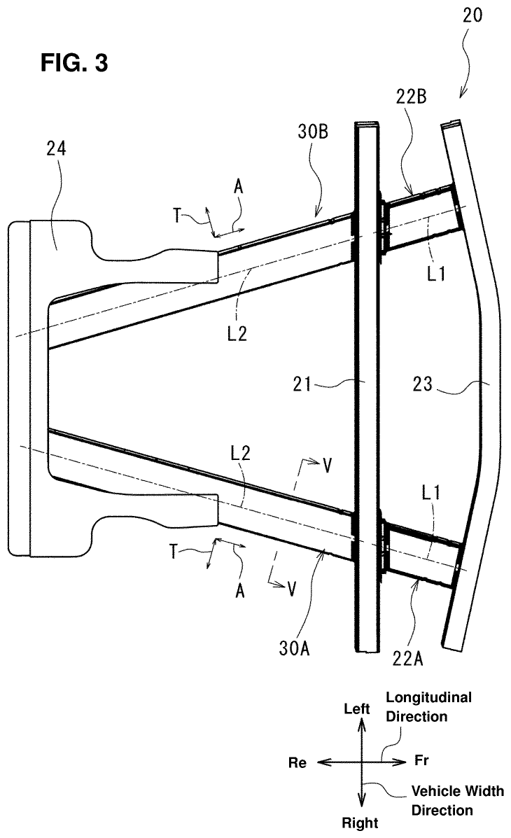

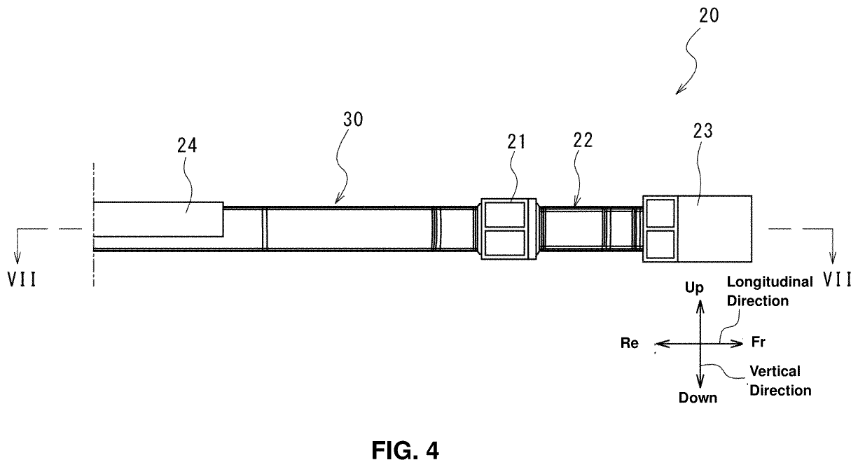

FIG. 3 is a plan view of the upper structural body 20. FIG. 4 is a side view of the upper structural body 20. Referring to FIGS. 3 and 4, the lower structural body 20 comprises a pair of front subframes 30A, 30B, a cross member 21, a pair of sub crash cans 22A, 22B, and a sub bumper reinforcement 23. In the flowing description, in a case where the pair of front subframes 30A, 30B need not to be referred to separately, one of these frames 30A, 30B will be described as a front subframe 30 simply sometimes. Likewise, in a case where the pair of sub crash cans 22A, 22B need not to be referred to separately, one of these crash cans 30A, 30B will be described as a sub crash can 22 simply sometimes.

The pair of front subframes 30A, 30B are arranged in the vehicle width direction with a specified gap formed therebetween. The front subframe 30 extends obliquely forward-and-outward, in the vehicle width direction, of the vehicle body (hereinafter, referred to as an extension direction A sometimes). Specifically, the right-side front subframe 30A extends obliquely forward-and-rightward, and the left-side front subframe 30B extends obliquely forward-and-leftward. Thus, the pair of front subframe 30A, 30B extend forward such that these frames 30A, 30B go away from each other. Hereinafter, the extension direction A of the front side frame 11 will be described as the extension direction A simply sometimes, and a horizontal direction in a plane perpendicular to the extension direction A will be described as a lateral direction T sometimes. The extension direction A matches an axial direction of the front subframe 30. The front subframe 30 of the present embodiment is an example of the frame member for the vehicle according to the present invention.

A front end of the front subframe 30 is connected to the cross member 21. A rear end of the front subframe 30 is attached to another structural body, such as a battery case (not illustrated) for installing batteries (not illustrated), via a frame bracket 24. As shown in FIG. 1, the front subframe 30 is arranged below the front side frame 11.

The front subframe 30 is an extruded aluminum frame. A sectional shape of a cross section of the front subframe 30 which is perpendicular to its extension direction A is substantially the same over its whole length along the extension direction A.

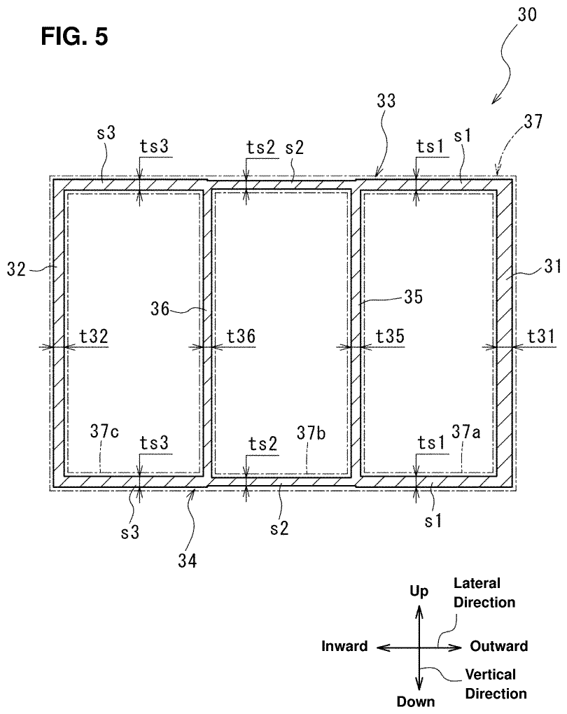

FIG. 5 is a sectional view taken along line V-V of FIG. 3. FIG. 5 is the sectional view showing the cross section of the front subframe 30 which is perpendicular to its extension direction A. A lateral direction in FIG. 5 matches the above-described lateral direction T. The right side in FIG. 5 is located on the outward side, in the vehicle width direction, of the vehicle body, and the left side in FIG. 5 is located on the inward side, in the vehicle width direction, of the vehicle body. While the following description will be conducted referring to the front subframe 30A shown in FIG. 5, the front subframe 30B has the same constitution as the front subframe 30A.

Referring to FIG. 5, the front subframe 30 comprises a first vertical wall 31, a second vertical wall 32, a first lateral wall 33, a second lateral wall 34, a first inner wall 35, and a second inner wall 36. The front subframe 30 has a rectangular closed-cross section as its cross section shown in FIG. 5.

The first vertical wall 31 is a plate member which has its longitudinal direction along the extension direction A, its short direction along the vertical direction, and its thickness direction along the lateral direction T. The first vertical wall 31 extends in the vertical direction as a whole in the cross section shown in FIG. 5. The first vertical wall 31 forms part of an external shape of the front subframe 30. Specifically, the first vertical wall 31 forms an outward side wall, in the vehicle width direction, of the front subframe 30.

The second vertical wall 32 is another plate member which has its longitudinal direction along the extension direction A, its short direction along the vertical direction, and its thickness direction along the lateral direction T. The second vertical wall 32 extends in the vertical direction as a whole in the cross section shown in FIG. 5. The second vertical wall 32 forms another part of the external shape of the front subframe 30. Specifically, the second vertical wall 32 forms an inward side wall, in the vehicle width direction, of the front subframe 30. The second vertical wall 32 is arranged on the inward side, in the vehicle width direction, of the first vertical wall 31. The second vertical wall 32 is arranged away from the first vertical wall 31 in the vehicle width direction.

The first lateral wall 33 is another plate member which has its longitudinal direction along the extension direction A, its short direction along the lateral direction T, and its thickness direction along the vertical direction. The first lateral wall 33 extends in the lateral direction T such that it interconnects respective upper ends of the first vertical wall 31 and the second vertical wall 32 in the cross section shown in FIG. 5. In other words, the first lateral wall 33 extends in the vehicle width direction such that it interconnects the respective upper ends of the first vertical wall 31 and the second vertical wall 32. The first lateral wall 33 forms another part of the external shape of the front subframe 30. Specifically, the first lateral wall 33 forms an upper wall of the front subframe 30.

The second lateral wall 34 is another plate member which has its longitudinal direction along the extension direction A, its short direction along the lateral direction T, and its thickness direction along the vertical direction. The second lateral wall 34 extends in the lateral direction T such that it interconnects respective lower ends of the first vertical wall 31 and the second vertical wall 32 in the cross section shown in FIG. 5. In other words, the second lateral wall 34 extends in the vehicle width direction such that it interconnects the respective lower ends of the first vertical wall 31 and the second vertical wall 32. The second lateral wall 34 forms another part of the external shape of the front subframe 30. Specifically, the second lateral wall 34 forms a lower wall of the front subframe 30. The second lateral wall 34 is arranged below the first lateral wall 33. The second lateral wall 34 is arranged away from the first lateral wall 33 in the vertical direction.

Each of the first lateral wall 33 and the second lateral wall 34 comprises a first portion s1, a second portion s2, and a third portion s3. The first portion s1 extends in the lateral direction T such that it interconnects the first vertical wall 31 and the first inner wall 35 in the cross section shown in FIG. 5. The second portion s2 extends in the lateral direction T such that it interconnects the first inner wall 35 and the second inner wall 36 in the cross section shown in FIG. 5. The third portion s3 extends in the lateral direction T such that it interconnects the second vertical wall 32 and the second inner wall 36 in the cross section shown in FIG. 5.

The first inner wall 35 is another plate member which has its longitudinal direction along the extension direction A, its short direction along the vertical direction, and its thickness direction along the lateral direction T. The first inner wall 35 extends in the vertical direction such that it interconnects the first lateral wall 33 and the second lateral wall 34 in the cross section shown in FIG. 5. The first inner wall 35 is arranged between the first vertical wall 31 and the second vertical wall 32 in the lateral direction T. In other words, the first lateral wall 33 is arranged between the first vertical wall 31 and the second vertical wall 32 in the vehicle width direction.

The second inner wall 36 is another plate member which has its longitudinal direction along the extension direction A, its short direction along the vertical direction, and its thickness direction along the lateral direction T. The second inner wall 36 extends in the vertical direction such that it interconnects the first lateral wall 33 and the second lateral wall 34 in the cross section shown in FIG. 5. The second inner wall 36 is arranged between the second vertical wall 32 and the first inner wall 35 in the lateral direction T. In other words, the second inner wall 36 is arranged on the inward side, in the vehicle width direction, of the first inner wall 35 in the vehicle width direction.

As shown in FIG. 5, the front subframe 30 has a closed-cross section 37 which is formed by the first vertical wall 31, the second vertical wall 32, the first lateral wall 33, and the second lateral wall 34. In other words, the first vertical wall 31, the second vertical wall 32, the first lateral wall 33, and the second lateral wall 34 form together the closed-cross section 37 as the external shape of the front subframe 30. Further, the first vertical wall 31, the first inner wall 35, and the respective first portions s1 of the first lateral wall 33 and the second lateral wall 34 form a first closed-cross section 37a. The first inner wall 35, the second inner wall 36, and the respective second portions s2 of the first lateral wall 33 and the second lateral wall 34 form a second closed-cross section 37b. The second vertical wall 32, the second inner wall 36, and the respective third portions s3 of the first lateral wall 33 and the second lateral wall 34 form a third closed-cross section 37c. Respective areas of the first closed-cross section 37a, the second closed-cross section 37b, and the third closed-cross section 37c are identical to each other.

In the present invention, the area of the closed-cross section means the total of areas of the plural walls forming the closed-cross section in the cross section perpendicular to the extension direction A (e.g., the cross section shown in FIG. 5), which does not include areas enclosed by the plural walls forming the closed-cross section. Further, in the present invention, the meaning of “the respective areas of the first closed-cross section 37a, the second closed-cross section 37b, and the third closed-cross section 37c are identical to each other” includes an embodiment in which these three areas are exactly the same and another embodiment in which these three areas are substantially the same. In the present embodiment, two of these three areas are within a range of 90-110% of the other one.

In the present embodiment, the first closed-cross section 37a, the second closed-cross section 37b, and the third closed-cross section 37c are substantially congruence. Specifically, the respective heights, i.e., the respective dimensions along the vertical direction, of the first vertical wall 31, the second vertical wall 32, the first inner wall 35, and the second inner wall 36 are substantially the same, and the respective widths, i.e., the respective dimensions along the lateral direction T, of the first portion s1, the second portion s2, and the third portion s3 are substantially the same.

The bending rigidity of the first vertical wall 31 is larger than that of the second vertical wall 32. Further, the bending rigidity of the second vertical wall 32 is larger than that of the first inner wall 35. Moreover, the bending rigidity of the first inner wall 35 is larger than that of the second inner wall 36. In other words, the respective bending rigidities of those become larger in order of the first vertical wall 31, the second vertical wall 32, the first inner wall 35, and the second inner wall 36.

In the present invention, the bending rigidity of the plate member, including the first vertical wall 31, the second vertical wall 32, the first lateral wall 33, the second lateral wall 34, the first inner wall 35, and the second inner wall 36, means the bending rigidity against a bending moment which is applied to the plate member in its thickness direction from both end portions, in the longitudinal direction, of the plate member, i.e., in its extension direction A.

In the present embodiment, the larger bending rigidity of the first vertical wall 31 than the second vertical wall 32 is attained by setting the thickness t31 of the first vertical wall 31, i.e., its dimension along the lateral direction T, to be larger than the thickness t32 of the second vertical wall 32. Further, the larger bending rigidity of the second vertical wall 32 than the first inner wall 35 is attained by setting the thickness t32 of the second vertical wall 32 to be larger than the thickness t35 of the first inner wall 35. Likewise, the larger bending rigidity of the first inner wall 35 than the second inner wall 36 is attained by setting the thickness t35 of the first inner wall 35 to be larger than the thickness t36 of the second inner wall 36. Herein, as described above, the height, i.e., the dimension along the vertical direction, is set at the same value among the first vertical wall 31, the second vertical wall 32, the first inner wall 35, and the second inner wall 36.

The bending rigidity of the first portion s1 is larger than that of the second portion s2. The bending rigidity of the third portion s3 is larger than that of the second portion s2. The bending rigidity of the first portion s1 is identical to that of the third portion s3. In the present embodiment, by setting the thickness ts1, i.e., the dimension along the vertical direction, of the first portion s1 to be larger than the thickness ts2 of the second portion s2, the bending rigidity of the first portion s1 is larger than that of the second portion s2. Likewise, the bending rigidity of the third portion s3 is set to be larger than that of the second portion s2 by making the thickness ts3, i.e., the dimension along the vertical direction, of the third portion s3 be larger than the thickness ts2 of the second portion s2. Herein, the widths, i.e., the dimension along the lateral direction T, of the first portion s1, the second portion s2, and the third portion s3 are substantially identical to each other.

Referring to FIG. 3, the cross member 21 extends in the vehicle width direction so as to interconnect respective front ends of the front subframes 30A, 30B. The cross member 21 is an extruded aluminum member. Further, the cross member 21 has a closed-cross section in its cross section perpendicular to the vehicle width direction.

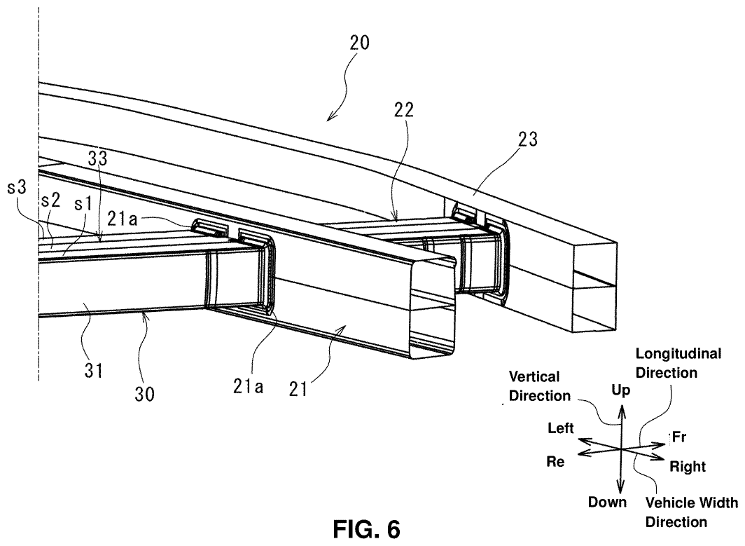

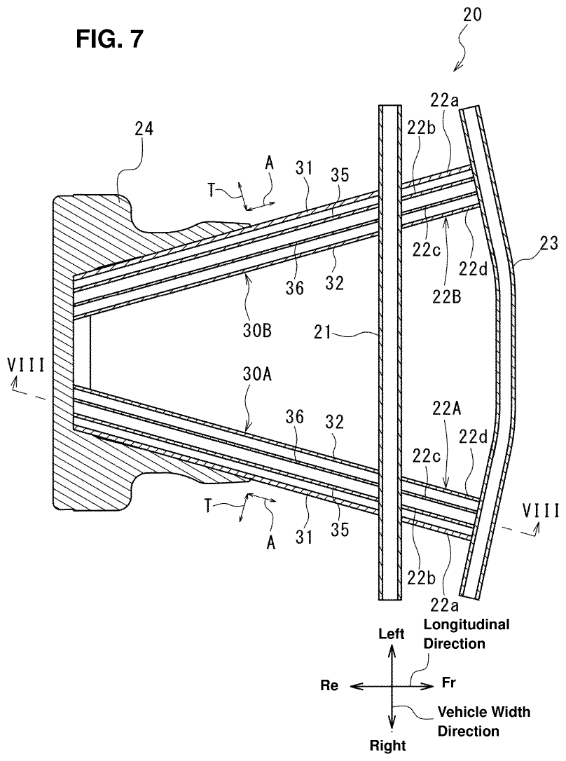

FIG. 6 is a perspective view of the cross member 21, when viewed from an oblique rearward side. As shown in FIG. 6, a joint portion 21a where the cross member 21 and the front subframe 30 are joined together is formed at a side face of a rear part of the cross member 21. The joint portion 21a of the present embodiment is welding marks of welding of the cross member 21 and the front subframe 30. In the present embodiment, the first vertical wall 31, the second vertical wall 32, and the respective first and third portions s1, s3 of the first lateral wall 33 and the second lateral wall 34 are welded to the cross member 21.

Referring to FIG. 3, the crash can 22 is the member to absorb the collision load applied from the oblique forward side. The pair of sub crash cans 22A, 22B are arranged with a specified gap formed therebetween in the vehicle width direction. The sub crash can 22 extends obliquely forward-and-outward, in the vehicle width direction, of the vehicle body. Specifically, the sub crash can 22A extends obliquely forward-and-rightward and the sub crash can 22B extends obliquely forward-and-leftward. The main crash can 21 of the present embodiment is aluminum-made. The sub crash can 22 of the present embodiment is an example of an impact absorbing member according to the present invention.

The sub crash can 22 is arranged between the cross member 21 and the sub bumper reinforcement 23. A front end of the sub crash can 22 is welded to the sub bumper reinforcement 23. Thus, the sub crash cans 22A, 22B are connected to each other via the sub bumper reinforcement 23. A rear end of the sub crash can 22 is welded to the cross member 21.

The sub crash cans 22A, 22B extend in the same directions as the corresponding front sub frames 30A, 30B. In other words, the sub crash cans 22A, 22B extend in the extension directions A of the corresponding front sub frames 30A, 30B. Each axial line L1 of the sub crash cans 22A, 22B matches each axial line L2 of the corresponding front subframes 30A, 30B. Herein, the meaning of “each axial line L1 of the sub crash cans 22A, 22B matches each axial line L2 of the corresponding front subframes 30A, 30B” includes an embodiment in which the axial line L1 of the sub crash cans 22A, 22B exactly match the axial line L2 of the corresponding front subframes 30A, 30B and another embodiment in which the axial line L1 of the sub crash cans 22A, 22B is slightly offset from the axial line L2 of the corresponding front subframes 30A, 30B.

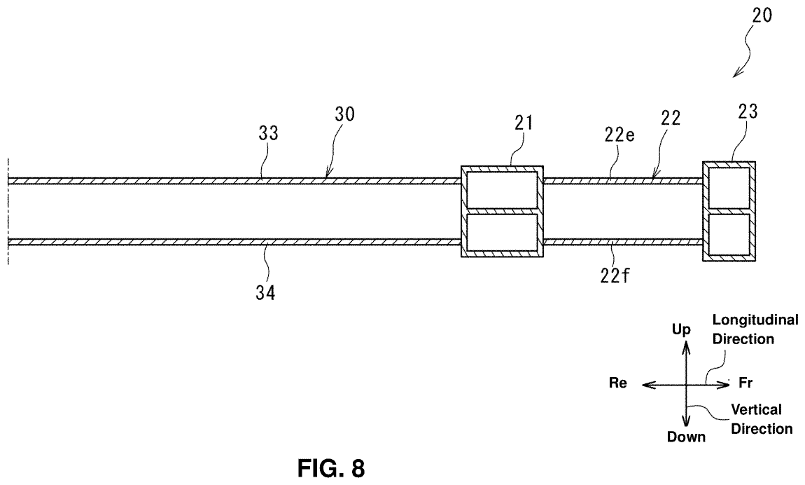

The sub crash can 22, not illustrated, has the closed-cross section in its cross section perpendicular to the extension direction A, which is similar to the front subframe 30. The sub crash can 22 has four vertical walls 22a-22d (shown in FIG. 7) which extend in the vertical direction and arranged with a specified gap formed therebetween in the lateral direction T in its cross section perpendicular to the extension direction A, and two lateral walls 22e, 22f (shown in FIG. 8) which extend in the lateral direction T and arranged with a specified gap formed therebetween in the vertical direction in its cross section perpendicular to the extension direction A. The upper-side lateral wall 22e interconnects upper ends of the four vertical walls 22a-22d, and the lower-side lateral wall 22f interconnects respective lower ends of the four vertical walls 22a-22d. Hereinafter, sometimes the lateral wall 22e will be called the upper wall 22e, and the lateral wall 22f will be called lower wall 22f.

FIG. 7 is a sectional view taken along line VII-VII of FIG. 4. The four vertical walls 22a-22d of the sub crash can 22 are position-aligned with the corresponding first vertical wall 31, the first inner wall 35, the second inner wall 36, and the second vertical wall 32 of the front subframe 30 in the lateral direction T as shown in FIG. 7. Herein, the description of “the walls are position-aligned with the walls in the lateral direction T” means that these walls overlap each other totally (as a whole) or partially in the lateral direction T.

FIG. 8 is a sectional view taken along line VIII-VIII of FIG. 7. The two lateral walls 22e, 22f of the sub crash can 22 are position-aligned with the corresponding first lateral wall 33 and the second lateral wall 34 of the front subframe 30 in the vertical direction as shown in FIG. 8. Herein, the description of “the walls are position-aligned with the walls in the vertical direction” means that these walls overlap each other totally (as a whole) or partially in the vertical direction.

The sub bumper reinforcement 23 extends in the vehicle width direction. Respective front ends of the sub crash cans 22A, 22B are fixed to the sub bumper reinforcement 23. Thus, the sub crash cans 22A, 22B are interconnected by the sub bumper reinforcement 23.

When the collision load is applied to the sub bumper reinforcement 23 from the oblique forward side, part of the collision load is absorbed by the sub crash can 22 and the front subframe 30. Specifically, when the collision load is applied to the sub bumper reinforcement 23 from the oblique forward side, the sub crash 22 and the front subframe 30 are so compressed in their extension directions A that the collision load can be absorbed by these members 22, 30.

The vehicle-body front structure 1 and the front subframe 30 according to the present embodiment produce the following operations/effects.

(1) The frame member for the vehicle 30 (the front subframe in the present embodiment) which extends in the longitudinal direction, has the closed-cross section perpendicular to the extension direction A, and is configured to absorb the collision load by the impact absorbing member 22 (the sub crash can in the present embodiment) arranged in front thereof, comprising the first vertical wall 31 extending in the vertical direction at the closed-cross section, the second vertical wall 32 arranged on the inward side, in the vehicle width direction, of the first vertical wall 31 and extending in the vertical direction at the closed-cross section, the first lateral wall 33 extending in the vehicle width direction at the closed-cross section, interconnecting the respective upper ends of the first vertical wall 31 and the second vertical wall 32, the second lateral wall 34 extending in the vehicle width direction at the closed-cross section, interconnecting the respective lower ends of the first vertical wall 31 and the second vertical wall 32, and forming the closed-cross section together with the first vertical wall 31, the second vertical wall 32, and the first lateral wall 33, the first inner wall 35 arranged between the first vertical wall 31 and the second vertical wall 32 in the vehicle width direction and extending in the vertical direction at the closed-cross section, interconnecting the first lateral wall 33 and the second lateral wall 34, and the second inner wall 36 arranged between the second vertical wall 32 and the first inner wall 35 in the vehicle width direction and extending in the vertical direction at the closed-cross section, interconnecting the first lateral wall 33 and the second lateral wall 34, wherein each of the first lateral wall 33 and the second lateral wall 34 comprises the first portion s1 interconnecting the first vertical wall 31 and the first inner wall 35, a second portion s2 interconnecting the first inner wall 35 and the second inner wall 36, and a third portion s3 interconnecting the second vertical wall 32 and the second inner wall 36, and each bending rigidity of the first portion s1 and the third portion s3 is larger than that of the second portion s2.

According to this structure, since the bending rigidity of the first portion s1 and the bending rigidity of the third portion s3 are larger than that of the second portion s2, the support rigidity for supporting the impact absorbing member 22 can be enhanced, compared to a case where the bending rigidity of the first portion s1 and the bending rigidity of the third portion s3 are smaller than that of the second portion s2. Thereby, when the collision load is applied to the vehicle-body front structure from the forward side, the impact absorbing member 22 is compressed easily, so that the impact absorbing member 22 is suppressed from being deformed unexpectedly. Consequently, the collision load is transmitted to the frame member 30 from the impact absorbing member 22 efficiently, so that the collision-load absorption amount (function) by means of the frame member 30 can be improved, compared to the case where the impact absorbing member 22 is deformed unexpectedly.

If the bending rigidity of the second portion s2 is extremely large, when the collision load is applied to the frame member 30 from the forward side, there is a case where the second portion s2 hinders the compression of the frame member 30 along the extension direction A. According to the present embodiment, however, since the bending rigidity of the second portion s2 is smaller than that of the first portion s1 and the third portion s3, it can be suppressed that the second portion s2 hinders the compression of the frame member 30 along the extension direction A, compared to a case where the bending rigidity of the second portion s2 is that of the first portion s1 and the third portion s3 or larger. Thereby, the frame member 30 is easily and uniformly compressed in the extension direction A even when the collision load is applied to the frame member 30 from the forward side. Consequently, the collision-load absorption amount (function) by means of the frame member 30 can be improved, compared to the case where the bending rigidity of the second portion s2 is that of each of the first portion s1 and the third portion s3 or larger.

(2) The first vertical wall 31, the first inner wall 35, and the respective first portions s1 of the first lateral wall 33 and the second lateral wall 34 form the first closed-cross section 37a at the above-described closed-cross section. The first inner wall 35, the second inner wall 36, and the respective second portions s2 of the first lateral wall 33 and the second lateral wall 34 form the second closed-cross section 37b at the above-described closed-cross section. The second vertical wall 32, the second inner wall 36, and the respective third portions s3 of the first lateral wall 33 and the second lateral wall 34 form the third closed-cross section 37c at the above-described closed-cross section. The area of the first closed-cross section 37a, the area of the second closed-cross section 37b, and the area of the third closed-cross section 37c are identical to each other. Accordingly, each moment of inertia of the respective closed-cross sections against the bending moment which is applied to the frame member 30 in its extension direction A from both end portions, in the longitudinal direction, of the frame member 30 has the same value. Consequently, the local buckling can be properly suppressed from occurring at the frame member 30, and the frame member 30 is so easily compressed uniformly in the extension direction A that the collision-load absorption amount (function) by means of the frame member 30 can be improved.

(3) The frame member 30 is the front subframe 30 arranged below the front side frame 11 which is provided on the outward side, in the vehicle width direction, of the engine room E. Accordingly, even in a structure in which the collision load applied along the vehicle longitudinal direction is absorbed by the front side frame 11 and the collision load applied from the oblique forward side along the extension direction A is absorbed by the front subframe 30, the front subframe 30 can appropriately absorb the collision load applied along the vehicle longitudinal direction as well.

(4) The vehicle-body front structure 1 of the present embodiment is provided with the frame member 30 for the vehicle and the impact absorbing member 22 (the sub crash can in the present embodiment) arranged in front of the frame member for the vehicle, wherein the axial line L1 of the impact absorbing member 22 matches the axial line L2 of the frame member 30 for the vehicle. Accordingly, the collision load is so easily transmitted from the impact absorbing member 22 to the frame member 30 that the collision-load absorption amount (function) by means of the frame member 30 can be improved.

(5) The impact absorbing member 22 comprises the upper wall 22e extending in the vehicle width direction at the above-described closed-cross section and the lower wall 22f arranged below the upper wall 22e with the specified gap therebetween and extending in the vehicle width direction at the above-described closed-cross section. The upper and lower walls 22e, 22f of the impact absorbing member 22 are position-aligned with the corresponding first and second lateral walls 33, 34 of the frame member 30 in the vertical direction. Thereby, the collision load is so easily transmitted from the upper and lower walls 22e,22f of the impact absorbing member 22 to the first and second walls 33, 34 of the frame member 30.

Consequently, the frame member 30 is so easily compressed uniformly in the extension direction A that the collision-load absorption amount (function) by means of the frame member 30 can be improved.

Herein, the present invention is not limited to the above-described embodiment and any modifications are applicable.

While the above-described embodiment exemplified the front subframe 30 as the example of the frame member for the vehicle according to the present invention, any other frame member is applicable.

While the above-described embodiment is configured such that the front subframe 30 comprises the two inner walls, i.e., the first inner wall 35 and the second inner wall 36, the front subframe 30 may have three or more inner walls.

Further, while the respective thickness of the plural portions, i.e., the thickness t31 of the first vertical wall 31, the thickness t32 of the second vertical wall 32, the thickness t35 of the first inner wall 35, and the thickness t36 of the second inner wall 36 are different from each other in the above-described embodiment, these may be the same.

Moreover, the sub crash can 22 is not limited to the above-described embodiment in which its cross section perpendicular to the extension direction A has the same sectional shape as the front subframe 30.

### Additional Notes

The present invention includes the following aspects.

### First Aspect

The frame member for the vehicle, which extends in the longitudinal direction, has the closed-cross section perpendicular to the extension direction thereof, and is configured to absorb the collision load by the impact absorbing member arranged in front thereof, comprising the first vertical wall extending in the vertical direction at the closed-cross section, the second vertical wall arranged on the inward side, in the vehicle width direction, of the first vertical wall and extending in the vertical direction at the closed-cross section, the first lateral wall extending in the vehicle width direction at the closed-cross section, interconnecting the respective upper ends of the first vertical wall and the second vertical wall, the second lateral wall extending in the vehicle width direction at the closed-cross section, interconnecting the respective lower ends of the first vertical wall and the second vertical wall, and forming the closed-cross section together with the first vertical wall, the second vertical wall, and the first lateral wall, the first inner wall arranged between the first vertical wall and the second vertical wall in the vehicle width direction and extending in the vertical direction at the closed-cross section, interconnecting the first lateral wall and the second lateral wall, and the second inner wall arranged between the second vertical wall and the first inner wall in the vehicle width direction and extending in the vertical direction at the closed-cross section, interconnecting the first lateral wall and the second lateral wall, wherein each of the first lateral wall and the second lateral wall comprises the first portion interconnecting the first vertical wall and the first inner wall, the second portion interconnecting the first inner wall and the second inner wall, and the third portion interconnecting the second vertical wall and the second inner wall, and each bending rigidity of the first portion and the third portion is larger than that of the second portion.

### Second Aspect

The frame member for the vehicle of the first aspect, wherein the first vertical wall, the first inner wall, and the respective first portions of the first lateral wall and the second lateral wall form the first closed-cross section at the closed-cross section, the first inner wall, the second inner wall, and the respective second portions of the first lateral wall and the second lateral wall form the second closed-cross section at the closed-cross section, the second vertical wall, the second inner wall, and the respective third portions of the first lateral wall and the second lateral wall form the third closed-cross section at the closed-cross section, and the area of the first closed-cross section, the area of the second closed-cross section, and the area of the third closed-cross section are identical to each other.

### Third Aspect

The frame member for the vehicle of the first or second aspects, wherein the frame member is the front subframe arranged below the front side frame which is provided on the outward side, in the vehicle width direction, of the engine room.

### Forth Aspect

The vehicle-body front structure which is provided with the frame member for the vehicle of the first or second aspects and the impact absorbing member arranged in front of the frame member for the vehicle, wherein the axial line of the impact absorbing member matches the axial line of the frame member for the vehicle.

### Fifth Aspect

The vehicle-body front structure of the fourth aspect, wherein the impact absorbing member comprises the upper wall extending in the vehicle width direction at the closed-cross section and the lower wall arranged below the upper wall with the specified gap therebetween and extending in the vehicle width direction at the closed-cross section, and the upper and lower walls of the impact absorbing member are position-aligned with the corresponding first and second lateral walls of the front subframe in the vertical direction.

What is claimed is:

1. A frame member for a vehicle, which extends in a longitudinal direction, has a closed-cross section perpendicular to an extension direction thereof, and is configured to absorb a collision load by an impact absorbing member arranged in front thereof, comprising:
a first vertical wall extending in a vertical direction at said closed-cross section;
a second vertical wall arranged on an inward side, in a vehicle width direction, of the first vertical wall and extending in the vertical direction at said closed-cross section;
a first lateral wall extending in the vehicle width direction at said closed-cross section, interconnecting respective upper ends of the first vertical wall and the second vertical wall;
a second lateral wall extending in the vehicle width direction at said closed-cross section, interconnecting respective lower ends of the first vertical wall and the second vertical wall, and forming said closed-cross section together with the first vertical wall, the second vertical wall, and the first lateral wall;
a first inner wall arranged between the first vertical wall and the second vertical wall in the vehicle width direction and extending in the vertical direction at said closed-cross section, interconnecting the first lateral wall and the second lateral wall; and
a second inner wall arranged between the second vertical wall and the first inner wall in the vehicle width direction and extending in the vertical direction at said closed-cross section, interconnecting the first lateral wall and the second lateral wall,
wherein each of said first lateral wall and said second lateral wall comprises a first portion interconnecting said first vertical wall and said first inner wall, a second portion interconnecting the first inner wall and said second inner wall, and a third portion interconnecting said second vertical wall and the second inner wall, and
each bending rigidity of said first portion and said third portion is larger than that of said second portion.

2. The frame member for the vehicle of claim 1, wherein said first vertical wall, said first inner wall, and said respective first portions of the first lateral wall and the second lateral wall form a first closed-cross section at said closed-cross section, the first inner wall, said second inner wall, and said respective second portions of the first lateral wall and the second lateral wall form a second closed-cross section at said closed-cross section, said second vertical wall, the second inner wall, and said respective third portions of the first lateral wall and the second lateral wall form a third closed-cross section at said closed-cross section, and an area of said first closed-cross section, an area of said second closed-cross section, and an area of said third closed-cross section are identical to each other.

3. The frame member for the vehicle of claim 1, wherein said frame member is a front subframe arranged below a front side frame which is provided on an outward side, in the vehicle width direction, of an engine room.

4. A vehicle-body front structure which is provided with the frame member for the vehicle of claim 1 and the impact absorbing member arranged in front of the frame member for the vehicle, wherein an axial line of said impact absorbing member matches an axial line of said frame member for the vehicle.

5. The vehicle-body front structure of claim 4, wherein said impact absorbing member comprises an upper wall extending in the vehicle width direction at said closed-cross section and a lower wall arranged below said upper wall with a specified gap therebetween and extending in the vehicle width direction at said closed-cross section, and said upper and lower walls of the impact absorbing member are position-aligned with said corresponding first and second lateral walls of the front subframe in the vertical direction.

6. The frame member for the vehicle of claim 2, wherein said frame member is a front subframe arranged below a front side frame which is provided on an outward side, in the vehicle width direction, of an engine room.

7. A vehicle-body front structure which is provided with the frame member for the vehicle of claim 2 and the impact absorbing member arranged in front of the frame member for the vehicle, wherein an axial line of said impact absorbing member matches an axial line of said frame member for the vehicle.
